(19) United States
(12) Patent Application Publication
(10) Pub. No.: US 2016/0254558 A1
(43) Pub. Date: Sep. 1, 2016

(54) POLYMER ELECTROLYTE MEMBRANE FOR A FUEL CELL, METHOD FOR MANUFACTURING SAME, AND FUEL CELL COMPRISING SAME

(71) Applicant: INDUSTRY-ACADEMIC COOPERATION FOUNDATION, YONSEI UNIVERSITY, Seodaemum-gu, Seoul (KR)

(72) Inventors: Haksoo HAN, Seoul (KR); Kwangwon SEO, Seoul (KR); Jinuk KWON, Gyeonggi-do (KR); Kwang-In KIM, Seoul (KR)

(73) Assignee: Industry- Academic Cooperation foundation, Yonsei University, Seoul (KR)

(21) Appl. No.: 15/033,030

(22) PCT Filed: Sep. 16, 2014
(86) PCT No.: PCT/KR14/08614

§ 371 Date: Apr. 28, 2016

(30) Foreign Application Priority Data
Oct. 29, 2013 (KR) 10-2013-0129218

(51) Int. Cl. H01M 8/103; H01M 8/1072; H01M 8/1051

(52) U.S. Cl. CPC H01M 8/103; H01M 8/1051; H01M 8/1072; H01M 2008/1095

(57) ABSTRACT

The present disclosure relates to a polymer electrolyte membrane containing polybenzimidazole for a fuel cell and to a method for manufacturing the same. In the polymer electrolyte membrane containing polybenzimidazole for a fuel cell according to the present disclosure, carbon black or a metal-grafted porous filler based on carbon black or carbon black and silica is efficiently dispersed in polybenzimidazole, and physically and chemically bound with polybenzimidazole, and thus the polymer electrolyte membrane has excellent mechanical and thermal properties, can improve impregnating efficiency of phosphoric acid to exhibit high proton conductivity, and can reduce deterioration in ion conductivity of the electrolyte membrane due to the leakage of phosphoric acid.

### TECHNICAL FIELD

The present disclosure relates to a polymer electrolyte membrane for a fuel cell, a method for manufacturing the same and a fuel cell including the same. More particularly, the present disclosure relates to a polymer electrolyte membrane for a fuel cell which provides a polybenzimidazole-based polymer electrolyte membrane with improved heat resistance and mechanical strength, enhances an effect of impregnation with phosphoric acid, reduces degradation of the ion conductivity of an electrolyte membrane caused by leakage of phosphoric acid, and thus significantly improves proton conductivity, a method for manufacturing the same and a fuel cell including the same.

### BACKGROUND ART

Fuel cells may be classified into solid electrolyte fuel cells, molten carbonate fuel cells, phosphoric acid fuel cells, polymer electrolyte fuel cells, direct methanol fuel cells, or the like. In the case of a solid electrolyte fuel cell, a driving temperature of about 1000° C. provides high quality. A molten carbonate fuel cell and a phosphoric acid fuel cell provide high quality at a driving temperature of about 650° C. and about 200° C., respectively. In the case of a polymer electrolyte fuel cell, a driving temperature of about 80° C. provides high quality.

A polymer exchange membrane fuel cell (PEMFC) uses a polymer electrolyte and thus is also called a polymer electrolyte membrane (PEM) fuel cell. Such a polymer electrolyte fuel cell has a driving temperature of about 80° C., and thus can be driven at the lowest temperature among the above-mentioned four types of fuel cells. In addition, a polymer electrolyte fuel cell shows high energy density and efficiency, allows a quick change in output depending on power requirement to facilitate rapid operation and shutdown, and generates power in an eco-friendly manner. Recently, intensive studies have been conducted about a polymer electrolyte fuel cell operated at a high temperature of 100° C. or more. A fuel cell operated at high temperature shows improvement of electrochemical reaction, allows relatively easy water control, and provides a large temperature gradient between a stack and cooling water due to such a high operating temperature of a fuel cell. Thus, such a fuel cell has various advantages, including simplification of a cooling system, as compared to low-temperature fuel cells.

In the case of a currently used Nafion (perfluorinated sulfonic acid polymer available from Dupont Co.) polymer electrolyte membrane, it shows high resistance and high ion conductivity and allows application of a methanol modifying group and thus is used widely. However, at a temperature of 100° C. or more, it undergoes deterioration of physical properties, including mechanical and thermal stability and proton conductivity, resulting in rapid degradation of quality.

Therefore, many studies have been conducted to solve the problem of deterioration of an electrolyte membrane occurring under high-temperature conditions. Korean Patent Publication No. 10-0738788 discloses a polymer electrolyte membrane impregnated with phosphoric acid as proton conducting agent so that it may have high proton conductivity even at high temperature. However, a conventional polybenzimidazole-based resin polymer electrolyte membrane shows very low efficiency of impregnation with phosphoric acid, and thus has a difficulty in providing high proton conductivity.

### DISCLOSURE

### Technical Problem

A technical problem to be solved by the present disclosure is to provide a composite electrolyte membrane for a fuel cell which has a high phosphoric acid doping level and retention ratio, shows high ion conductivity, and is stable against heat.

Another technical problem to be solved by the present disclosure is to provide a method for manufacturing the composite electrolyte membrane for a fuel cell.

Still another technical problem to be solved by the present disclosure is to provide a fuel cell including the composite electrolyte membrane.

### Technical Solution

In one general aspect, there is provided a polymer electrolyte membrane for a fuel cell, including: a polybenzimidazole polymer; and carbon black, wherein the polybenzimidazole is a polymer including at least one of the repeating units represented by the following Chemical Formula 1-Chemical Formula 4, and the carbon black is used in an amount of 1-50 parts by weight based on 100 parts by weight of the polybenzimidazole polymer.

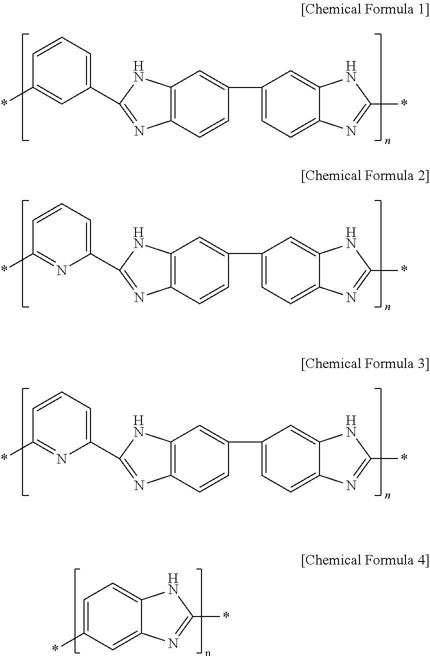

wherein n is an integer of 50-100,000.

According to an embodiment, the polymer electrolyte membrane for a fuel cell may further include a silica-based metal-grafted porous filler, and the metal-grafted porous filler may be present in an amount of 0.1-30 parts by weight based on 100 parts by weight of the polybenzimidazole polymer.

According to another embodiment, the repeating units represented by the above Chemical Formula 1-Chemical Formula 4 may be obtained by reacting a monomer represented by the following Chemical Formula 5 with any one monomer selected from the group consisting of the following Chemical Formula 6-Chemical Formula 8, or reacting a monomer represented by the following Chemical Formula 9:

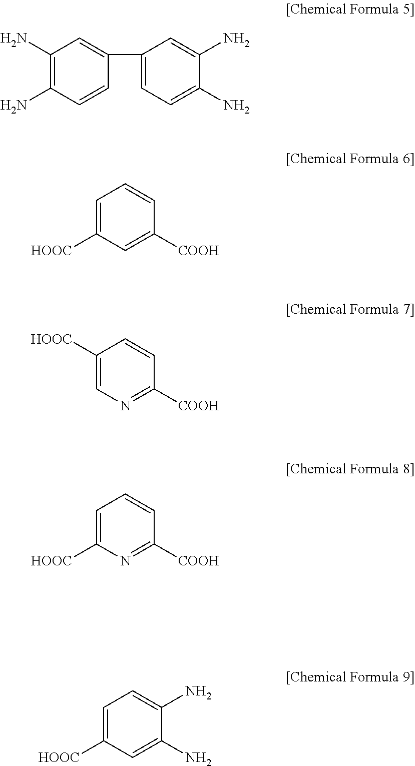 [SMILES: Nc1ccc(-c2ccc(N)c(N)c2)cc1N ; O=C(O)c1cccc(C(=O)O)c1 ; O=C(O)c1ccc(C(=O)O)nc1 ; O=C(O)c1cccc(C(=O)O)n1 ; Nc1ccc(C(=O)O)cc1N]

In addition, the repeating units represented by the above Chemical Formula 1-Chemical Formula 3 may be obtained according to the following Reaction Scheme 1:

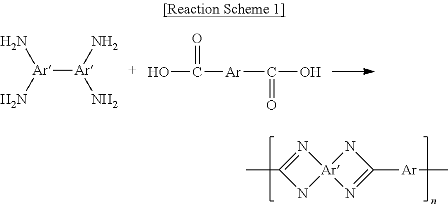

wherein Ar′ is a C6-C24 aryl group present alone or at least two aryl groups are bound to each other to form a condensed ring, Ar is a C6-C18 aryl group or C6-C18 hetero group, and n is an integer of 50-100,000.

According to still another embodiment, the carbon black may be selected from lamp black, channel black, thermal black, acetylene black and furnace black, and may include at least one functional group selected from a carboxyl group, hydroxyl group, ketone, lactone, pyrone and quinone.

According to still another embodiment, the polybenzimidazole may be a copolymer of two types of repeating units selected from the above Chemical Formula 1-Chemical Formula 4, and the two types of repeating units may be used in a molar ratio of 5:95-95:5.

In another aspect, there is provided a method for manufacturing a polymer electrolyte membrane for a fuel cell, including the steps of: (a) dispersing carbon black in an acidic solution to provide a dispersion solution; (b) reacting a monomer represented by the following Chemical Formula 5 with any one monomer selected from the monomers represented by the following Chemical Formula 6-Chemical Formula 8, or reacting a monomer represented by the following Chemical Formula 9 to provide a polybenzimidazole polymer; (c) mixing the dispersion solution of step (a) with the polybenzimidazole polymer of step (b), followed by agitation; and (d) casting the resultant mixed solution, followed by thermal curing.

According to an embodiment, in step (a), a silica-based metal-grafted porous filler may be further dispersed in the acidic solution in addition to carbon black.

In still another aspect, there is provided a method for manufacturing a polymer electrolyte membrane for a fuel cell, including the steps of: (a) adding carbon black, a monomer represented by the following Chemical Formula 5, and any one monomer selected from the monomers represented by the following Chemical Formula 6-Chemical Formula 8 to an acidic solution, and carrying out reaction to provide a mixed solution containing solid content; (b) adding carbon black and a monomer represented by the following Chemical Formula 9 to an acidic solution and carrying out reaction to provide a mixed solution containing solid content; and (c) casting the mixed solution of step (a) or (b), followed by thermal curing.

According to an embodiment, in step (a) and step (b) a silica-based metal-grafted porous structure may be further added to carry out reaction.

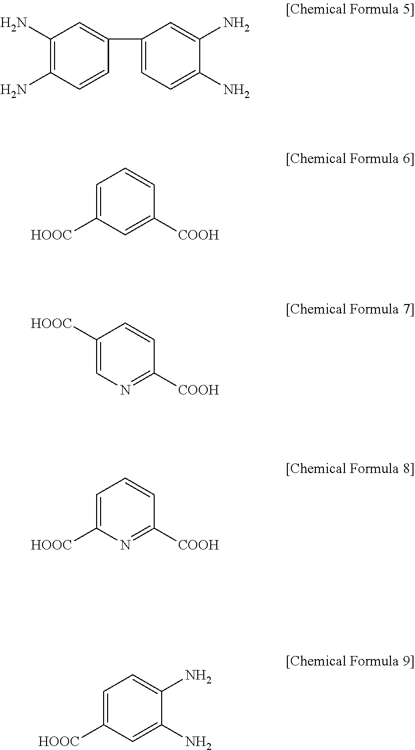 [SMILES: Nc1ccc(-c2ccc(N)c(N)c2)cc1N ; O=C(O)c1cccc(C(=O)O)c1 ; O=C(O)c1ccc(C(=O)O)nc1 ; O=C(O)c1cccc(C(=O)O)n1 ; Nc1ccc(C(=O)O)cc1N]

According to another embodiment, the acidic solution may be polyphosphoric acid or methanesulfonic acid.

According to still another embodiment, the solid content may be present in an amount of 5-50 wt % based on the weight of the mixed solution.

In yet another aspect, there is provided a fuel cell using the polymer electrolyte membrane for a fuel cell.

### Advantageous Effects

According to the embodiments of the present disclosure, the polymer electrolyte membrane for a fuel cell includes carbon black or carbon black and a silica-based metal-grafted porous filler dispersed efficiently in the polybenzimidazole polymer on the surface thereof, so that chemical bonds may be produced to form branches between the chains of the polybenzimidazole polymer and the carbon black or carbon black and the porous filler are dispersed physically in the interstitial volumes of the chains. As a result, the electrolyte membrane shows a high doping level with phosphoric acid, high retention ratio of phosphoric acid, and may be applied to a fuel cell driven at high temperature. In addition, when manufacturing the polymer electrolyte membrane according to the method disclosed herein, the contact area with phosphoric acid is increased by a random fiber structure and the acidic solution is retained homogeneously even in the inner part of the membrane. As a result, a phosphoric acid doping level and retention ratio are further increased. Particularly, since the electrolyte membrane use phosphoric acid as electrolyte solution, it is possible to solve the problems related with a water control system, CO poisoning and degradation of catalytic activity and to obtain the effects of reducing BOP (balance of plant), increasing efficiency and saving cost required for designing a system.

### DESCRIPTION OF DRAWINGS

FIG. 1 shows a chemical structure of carbon black.

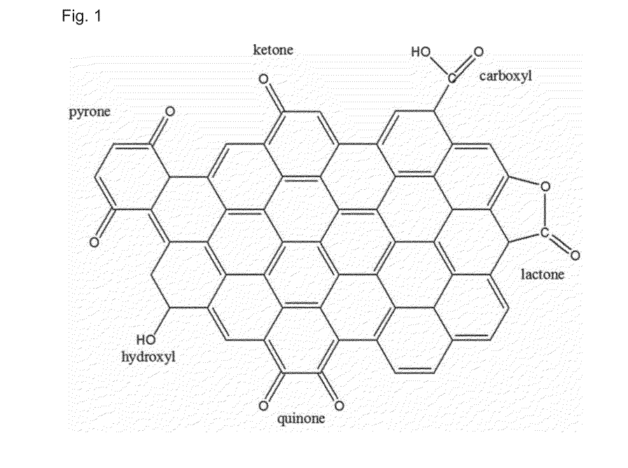

FIG. 2 is a graph illustrating the proton conductivity of the polymer electrolyte membrane according to Example 1.

FIG. 3 is a graph illustrating the proton conductivity of the electrolyte membrane according to Example 1 as compared to that of the electrolyte membrane according to Comparative Example 1.

FIG. 4 is a graph illustrating the proton conductivity of the electrolyte membrane according to Example 1 as compared to that of the Nafion electrolyte membrane available from Dupont Co.

FIG. 5 is a graph illustrating the proton conductivity of the electrolyte membrane according to Example 1 with the proton conductivity of each of the electrolyte membranes according to Comparative Examples 1 and 2 (0-50 hours).

FIG. 6 is a graph illustrating the proton conductivity of the electrolyte membrane according to Example 1 with the proton conductivity of each of the electrolyte membranes according to Comparative Examples 1 and 2 (0-500 hours).

FIG. 7 is a graph illustrating the proton conductivity of the electrolyte membrane according to Example 1 with the proton conductivity of each of the electrolyte membrane according to Comparative Example 2 and the commercially available Nafion electrolyte membrane.

FIG. 8 is a photograph illustrating a metal-grafted porous filler, taken by scanning electron microscopy (SEM).

FIG. 9 is a graph illustrating the proton conductivity of the electrolyte membrane according to Example 3.

### BEST MODE

Exemplary embodiments now will be described more fully hereinafter.

In one aspect, there is provided a polymer electrolyte membrane for a fuel cell including: a polybenzimidazole polymer; and carbon black, wherein the polybenzimidazole is a polymer including at least one of the repeating units represented by the following Chemical Formula 1-Chemical Formula 4, the carbon black is used in an amount of 1-50 parts by weight based on 100 parts by weight of the polybenzimidazole polymer, and the carbon black is dispersed in and bound to the polybenzimidazole.

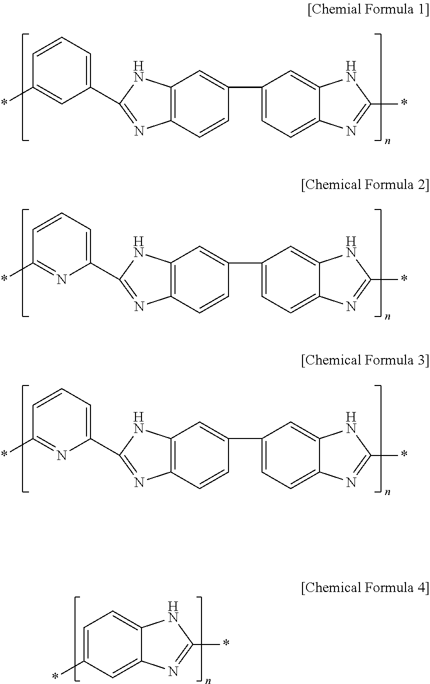

wherein n is an integer of 50-100,000.

According to the present disclosure, carbon black is introduced to a polybenzimidazole polymer to provide a polymer electrolyte membrane for a fuel cell, and thus the resultant electrolyte membrane has an increased surface area so that the amount of phosphoric acid to be impregnated may be increased, thereby increasing proton conductivity. In addition, in order to further increase the above-mentioned effect, the polymer electrolyte membrane for a fuel cell may further include a silica-based metal-grafted porous filler dispersed in the polybenzimidazole polymer, in addition to carbon black. Herein, the metal-grafted porous may be used in an amount of 0.1-30 parts by weight based on 100 parts by weight of the polybenzimidazole polymer.

The repeating units represented by the above Chemical Formula 1-Chemical Formula 4 may be obtained by reacting a monomer represented by the following Chemical Formula 5 with any one monomer selected from the group consisting of the following Chemical Formula 6-Chemical Formula 8, or reacting a monomer represented by the following Chemical Formula 9:

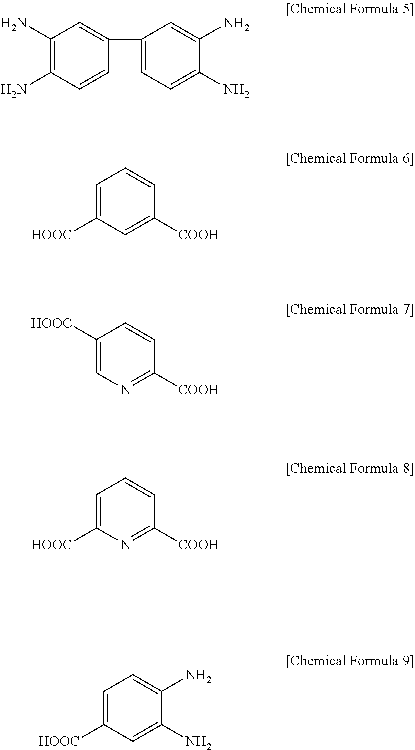 [SMILES: Nc1ccc(-c2ccc(N)c(N)c2)cc1N ; O=C(O)c1cccc(C(=O)O)c1 ; O=C(O)c1ccc(C(=O)O)nc1 ; O=C(O)c1cccc(C(=O)O)n1 ; Nc1ccc(C(=O)O)cc1N]

In addition, the repeating units represented by the above Chemical Formula 1 Chemical Formula 3 may be obtained according to the following Reaction Scheme 1:

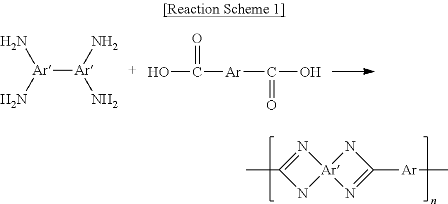

wherein Ar is a C6-C24 aryl group present alone or at least to aryl groups are bound to each other to form a condensed ring, Ar is a C6-C18 aryl group or C6-C18 hetero group, and n is an integer of 50-100,000.

According to an embodiment, the carbon black may be selected from lamp black, channel black, thermal black, acetylene black and furnace black. The properties of each carbon black are shown the following Table 1.

TABLE 1

| | | Channel | Thermal | Acetylene | Furnace |
|---|---|---|---|---|---|
| | Lamp black | black | black | black | black |
| Raw material | Crude oil | Natural gas | Natural gas | Acetylene gas | Crude oil |
| Process | Incomplete | Incomplete | Pyrolysis | Pyrolysis | Pyrolysis |
| | combustion | combustion | | (exothermic) | |
| Properties | | High volatile | Low | High purity | Productive |
| | | content | structural | High structural | |
| | | Low ash | | | |
| | | content | | | |
| Particle | 50-100 | 10-27 | 120-500 | 30-50 | 17-70 |
| diameter | | | | | |
| (μm/g) | | | | | |
| Surface area | 20-95 | 110-1125 | 6-15 | 60-70 | 20-200 |
| (cm³) | | | | | |
| Ash content | ~0.16 | ~0.1 | 0.02-0.38 | 0 | 0.1-1.0 |
| (%) | | | | | |
| Sulfur | — | ~0.1 | ~0.4 | 0.02 | 0.05-1.5 |
| content (%) | | | | | |

Particularly, the carbon black may be selected from Ecorax™ 1720, Ecorax™1830, Ecorax™1990, EB 1-5, Corax™HP 130, Ecorax™S 204, EB 247, Ecorax™1830, EB 247, Ecorax™S 204 and Ecorax™S 206 available from Evonik Company.

In addition, the carbon black may include at least one functional group selected from a carboxyl group, hydroxyl group, ketone, lactone, pyrone and quinine. The carbon black is bound both physically and chemically to polybenzimidazole by virtue of such various functional groups, and thus provides a polymer electrolyte membrane for a fuel cell having a high doping level with phosphoric acid, high phosphoric acid retention ratio and high thermal and mechanical stability even in the case of long-term use.

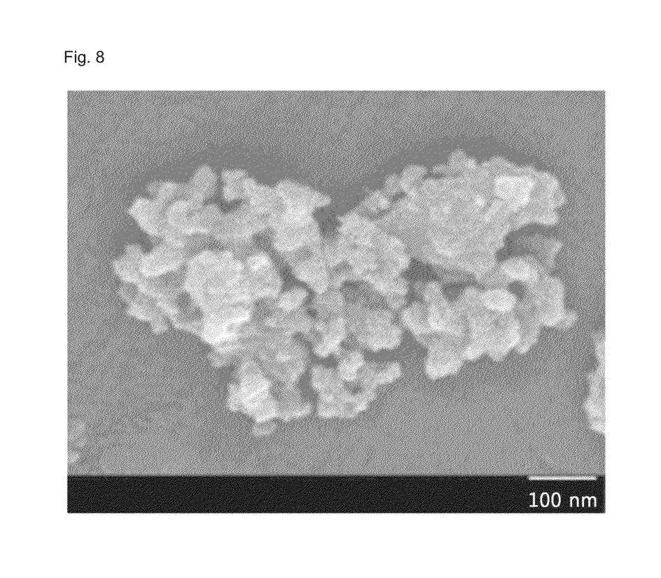

In addition, as mentioned above, a metal-grafted porous filler (FIG. 8) may be further dispersed in addition to carbon black. Herein, the metal-grafted porous filler is a silica-based porous material and includes aluminum added as additional element. The metal-grafted porous filler may have a structure of spherical particles, cylindrical or random three-dimensional radial structure.

The metal-grafted porous structure has an aluminum element introduced thereto in order to increase the affinity with phosphoric acid, and thus provides a polymer electrolyte membrane for a fuel cell with a high doping level with phosphoric acid, high phosphoric acid retention ratio and high thermal and mechanical stability even in the case of long-term use.

According to another embodiment, the polybenzimidazole may be a copolymer of two units selected from the above Chemical Formula 1-Chemical Formula 4, wherein the two units may be used in a molar ratio of 5:95-95:5.

In another aspect, there is provided a method for manufacturing a polymer electrolyte membrane for a fuel cell, including the steps of: (a) dispersing carbon black in an acidic solution to provide a dispersion solution; (b) reacting a monomer represented by the following Chemical Formula 5 with any one monomer selected from the monomers represented by the following Chemical Formula 6-Chemical Formula 8, or reacting a monomer represented by the following Chemical Formula 9 to provide a polybenzimidazole polymer; (c) mixing the dispersion solution of step (a) with the polybenzimidazole polymer of step (b), followed by agitation; and (d) casting the resultant mixed solution, followed by thermal curing.

According to an embodiment, in step (a), a silica-based metal-grafted porous filler may be further dispersed in the acidic solution in addition to carbon black so as to further improve the phosphoric acid doping level and phosphoric acid retention ratio.

In addition, according to a particular embodiment, step (d) may be carried out by a process including: i) precipitating the mixed solution to obtain powder and dissolving the powder into the acidic solution again, followed by casting and thermal curing, or ii) forming the mixed solution into fine fibers by using an electrospinning system and integrating the fibers randomly, followed by thermal curing, or by a direct casting process under the supply of water, and including: iii) supplying water under predetermine conditions after casting to carry out decomposition of the polyphosphoric acid solution used as acidic solution so that it may be converted into phosphoric acid to allow direct impregnation with phosphoric acid. When using the above-mentioned processes i)-iii), the inner surface area of an electrolyte membrane may be increased and the amount of phosphoric acid to be impregnated in the electrolyte membrane may be increased, thereby providing increased proton conductivity.

In still another aspect, there is provided a method for manufacturing a polymer electrolyte membrane for a fuel cell, including the steps of: (a) adding carbon black, a monomer represented by the following Chemical Formula 5, and any one monomer selected from the monomers represented by the following Chemical Formula 6-Chemical Formula 8 to an acidic solution and carrying out reaction, or reacting a monomer represented by Chemical Formula 9 to provide a mixed solution containing solid content; and (b) casting the mixed solution, followed by thermal curing.

According to an embodiment in step (a) and step (b), a silica-based metal-grafted porous structure may be further added to carry out reaction so as to further improve the phosphoric acid doping level and phosphoric acid retention ratio.

In addition, according to a particular embodiment, step (b) may be carried out by a process including: i) precipitating the mixed solution to obtain powder and dissolving the powder into the acidic solution again, followed by casting and thermal curing, or ii) forming the mixed solution into fine fibers by using an electrospinning system and integrating the fibers randomly, followed by thermal curing, or by a direct casting process under the supply of water, and including: iii) supplying water under predetermine conditions after casting to carry out decomposition of the polyphosphoric acid solution used as acidic solution so that it may be converted into phosphoric acid to allow direct impregnation with phosphoric acid. When using the above-mentioned processes i)-iii), the inner surface area of an electrolyte membrane may be increased and the amount of phosphoric acid to be impregnated in the electrolyte membrane may be increased, thereby providing increased proton conductivity.

The acidic solution may be polyphosphoric acid or methanesulfonic acid.

The mixed solution may have a solid content of 5-50 wt %.

In still another aspect, there is provided a fuel cell using the polymer electrolyte membrane according to the present disclosure. The fuel cell may be driven at a high temperature of 80° C. or more, and thus shows high energy efficiency and has higher industrial applicability as compared to a low-temperature fuel cell.

### MODE FOR INVENTION

Exemplary embodiments now will be described more fully hereinafter. It is apparent to those skilled in the art that the following examples are for illustrative purposes only and not intended to limit the scope of this disclosure.

The electrolyte membrane for a fuel cell including carbon black dispersed therein can be manufactured by the following two methods (Example 1 and Example 2) as described hereinafter in detail.

### Example 1

First 3.24 g (15.1 mmol) of 3,3′-diaminobenzidine and 2.51 g (15.1 mmol) of isophthalic acid are dissolved in 160 g of polyphosphoric acid. Next, the reaction mixture is heated to a temperature of 220° C. under nitrogen atmosphere in a system equipped with a reflux device and reaction is carried out for 30 hours.

After the completion of the reaction, precipitate is collected in water. Then, neutralization is carried out with potassium hydroxide (KOH) to pH 7. The reaction mixture is washed thoroughly with boiling water, filtered and dried in a vacuum oven for 24 hours. The obtained m-PBI powder is added to a solution in which carbon black is dispersed preliminarily in methanesulfonic acid in an amount of 10 parts by weight based on 100 parts by weight of polybenzimidazole polymer and the dissolved therein, followed by casting of a membrane. Then, the membrane is cured in an oven in a stepwise manner at 80° C. for 1 hour, at 100° C. for 1 hour, at 120° C. for 1 hour and at 160° C. for 2 hours to obtain an electrolyte membrane for a fuel cell including carbon black dispersed therein.

### Example 2

First, 3.24 g (15.1 mmol) of 3,3′-diaminobenzidine and 2.51 g (15.1 mmol) of isophthalic acid are dissolved in 160 g of polyphosphoric acid together with 10 parts by weight of carbon black based on 100 parts by weight of polybenzimidazole polymer. Next, the reaction mixture is heated to a temperature of 220° C. under nitrogen atmosphere in a system equipped with a reflux device and reaction is carried out for 30 hours.

After the completion of the reaction, precipitate is collected in water. Then, neutralization is carried out with potassium hydroxide (KOH) to pH 7. The reaction mixture is washed thoroughly with boiling water, filtered and dried in a vacuum oven for 24 hours. The obtained m-PBI powder is dispersed in methanesulfonic acid, followed by casting of a membrane. Then, the membrane is cured in an oven in a stepwise manner at 80° C. for 1 hour, at 100° C. for 1 hour, at 120° C. for 1 hour and at 160° C. for 2 hours to obtain an electrolyte membrane for a fuel cell including carbon black dispersed therein.

### Comparative Example 1

### PBI Including No Carbon Black

First, 3.235 g (15.1 mmol) of 3,3′-diaminobenzidine and 2.509 g (15.1 mmol) of isophthalic acid are dissolved in 160 g of polyphosphoric acid. Next, the reaction mixture is heated to a temperature of 220° C. under nitrogen atmosphere in a system equipped with a reflux device and reaction is carried out for 30 hours.

After the completion of the reaction, precipitate is collected in water. Then, neutralization is carried out with potassium hydroxide (KOH) to pH 7. The reaction mixture is washed thoroughly with boiling water, filtered and dried in a vacuum oven for 24 hours. The obtained m-PBI powder is dispersed in methanesulfonic acid, followed by casting of a membrane. Then, the membrane is cured in an oven in a stepwise manner at 80° C. for 1 hour, at 100° C. for 1 hour, at 120° C. for 1 hour and at 160° C. for 2 hours to obtain an electrolyte membrane for a fuel cell.

### Comparative Example 2

### PBI Including Metal-Grafted Porous Structure

To a three-necked flask, 100 g of polyphosphoric acid (PPA) is introduced and 0.01 mol of 3,3-diaminobenzidine and 0.01 mol of 2,5-pyridine dicarboxylate are added thereto. Next, the reaction mixture is heated gradually to 200° C. by using a reflux condenser under nitrogen atmosphere to carry out reaction for 30 hours, and then poured into deionized water and the resultant precipitate is filtered. The filtered product is titrated with 1M KOH solution and the titrated filtered product is washed with deionized water, followed by filtering and drying. The yield is 63%.

Then, 2.5 g of hexadecyltrimethylammonium bromide is dissolved in 90 g of water and 60 g of ethanol. After that, 1 g of aluminum chloride is added thereto as metal ions. Subsequently, 16.9 g of 25 wt % aqueous ammonia is added, followed by agitation for about 1 minute. Then, 4.7 g of tetraethyl orthosilicate (TEOS) is added gradually dropwise thereto. After the completion of the addition of TEOS, the reaction mixture is further agitated for about 2 hours, washed with water three to four times, and dried under vacuum at 60° C. The powder obtained after the vacuum drying is fired at 540° C. for about 5 hours at a heating rate of 2° C./min to remove the template from the powder. After the firing, the resultant powder is a metal-grafted porous structure, AI-MCM-41.

To provide a composite membrane, 2,5-polybenzimidzole obtained as described above is dissolved in methanesulfonic acid to obtain a polymer solution. Next, 5 wt % of AI-MCM-41 is added to the polymer solution. After the addition, ultrasonic energy is applied to carry out homogeneous mixing and the reaction mixture is agitated sufficiently to produce a viscous 2,5-polybenzimidazole solution. Then, each 2,5-polybenzimidazole solution having a different porous structure content is applied onto a glass plate through spin coating and cured by heating at 80° C. for 1 hour, at 100° C. for 1 hour, at 120° C. for 1 hour and at 160° C. for 2 hours. The resultant membrane is dipped in deionized water for 10 minutes, and then the film is removed from the glass plate

The film is dipped in a phosphoric acid solution for about 72 hours to impart ion conductivity thereto, wherein the phosphoric acid solution is an aqueous solution containing 85 wt % of phosphoric acid.

### Test Example 1

### Determination of Proton Conductivity

The efficiency of a fuel cell may be expressed by output voltage depending on charge density of a fuel cell. Since the charge density of a fuel cell depends on proton conductivity, an electrolyte membrane having high proton conductivity is particularly preferred for use in a polymer electrolyte membrane fuel cell (PEMFC). Proton conductivity may be determined by using electrochemical impedance spectroscopy technique in a frequency range of 100 kHz-10 Hz. Proton conductivity σ is calculated according to the following Mathematical Formula 1:

$$σ ( S / cm ) = \frac{D}{Is \times ws \times R} \qquad [ Mathematical Formula 1 ]$$

wherein D, Iₛ, wₛ and R represent a distance between electrodes, thickness of an electrolyte membrane, width of an electrolyte membrane and resistance of an electrolyte membrane, respectively.

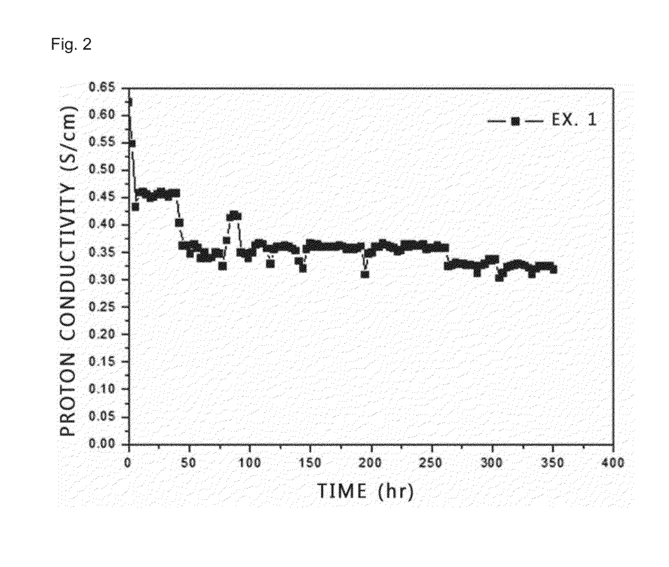

Each of the electrolyte membranes according to Example 1 and Comparative Examples 1 and 2 and the electrolyte membrane available from Dupont Co. is determined for proton conductivity by using Autolab impedance analyzer and a proton conductivity cell. The results are shown in the following Table 2. In addition, FIG. 2-FIG. 7 show the results in the form of a diagram in detail. Proton conductivity is determined at 150° C. However, Nafion cannot be operated at high temperature, and thus is operated at 80° C. under a humidified condition to determine proton conductivity.

TABLE 2

| | | | | | Proton |
|---|---|---|---|---|---|
| | | | | | conductivity |
| | Proton conductivity at 150° C. | | | | at 80° C. |
| | non-humidification (S/cm) | | | | humidification |
| Time (hr) | | | Comp. | | (S/cm) |
| Time (hr) | Ex. 1 | Comp. Ex. 1 | Ex. 2 | Nafion | Nafion |
| 1 | 0.6229 | 0.0832 | 0.421 | cannot be | 0.3972 |
| | | | | driven | |
| 5 | 0.4326 | 0.0533 | 0.3042 | cannot be | 0.1961 |
| | | | | driven | |
| 10 | 0.4579 | 0.0513 | 0.275 | cannot be | 0.1805 |
| | | | | driven | |
| 20 | 0.45109 | 0.0521 | 0.2566 | cannot be | 0.1922 |
| | | | | driven | |
| 50 | 0.3475 | 0.0497 | 0.23 | cannot be | 0.1750 |
| | | | | driven | |
| 70 | 0.3401 | 0.0495 | 0.2124 | cannot be | 0.1584 |
| | | | | driven | |
| 100 | 0.3392 | 0.0493 | 0.2101 | cannot be | 0.1494 |
| | | | | driven | |

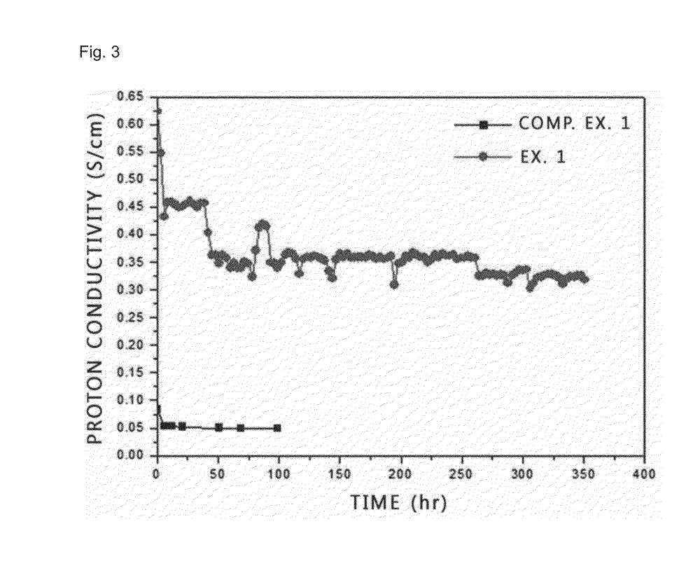

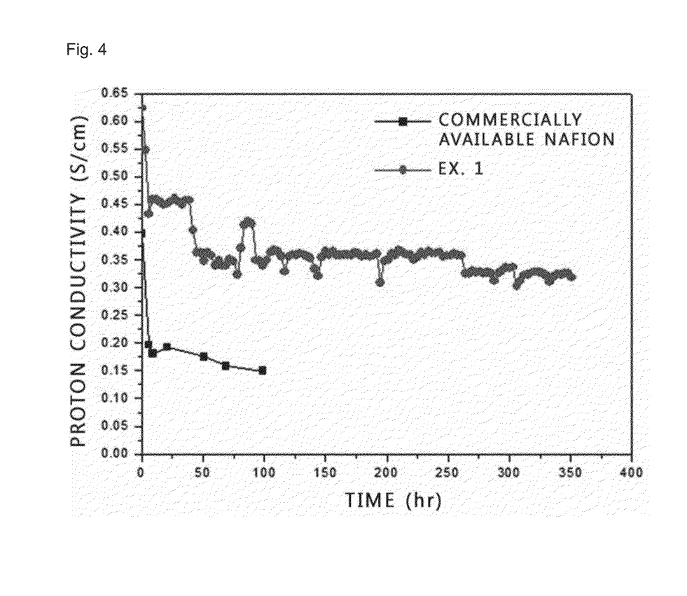

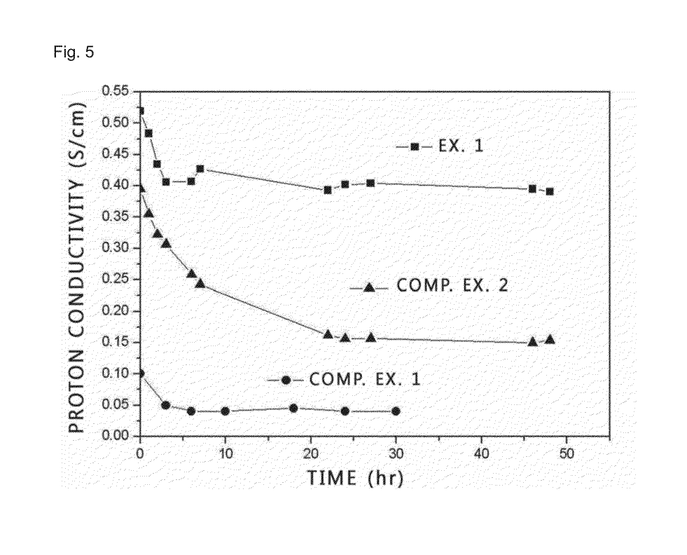

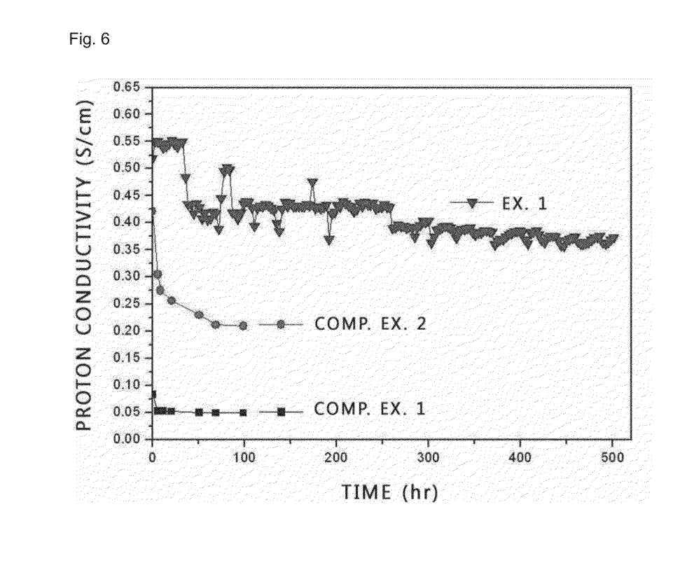

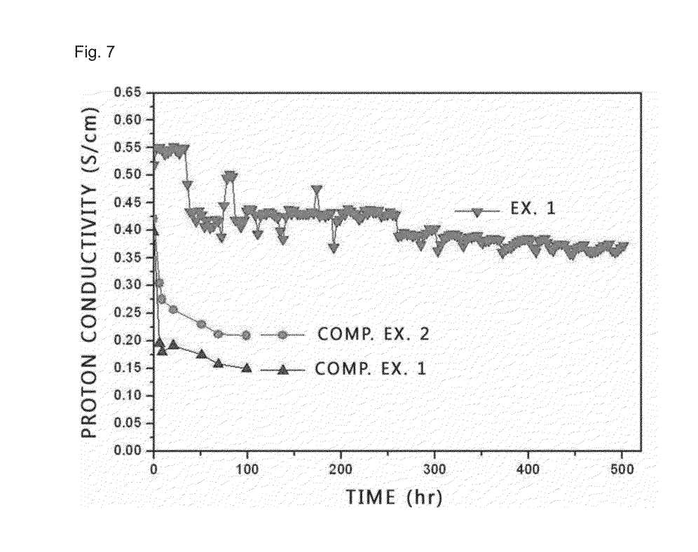

It can be seen from Table 2 and FIG. 2-FIG. 7 that proton conductivity decreases as the service time of an electrolyte membrane for a fuel cell increases. Example 1 maintains high quality (0.35 s/cm) even when it is driven for about 500 hours (FIG. 2). In addition, Example 1 shows proton conductivity improved by about 700% or more as compared to Comparative Example 1, and by about 200% as compared to Comparative Example 2 (FIG. 3, FIG. 5, FIG. 6 and FIG. 7). Under a non-humidified condition at 150° C., Nafion that is an electrolyte membrane available from Dupont Co., cannot be operated. Thus, Nafion is determined for proton conductivity at a low temperature of 80° C. under a humidified condition (FIG. 4). Based on the results of Table 2 and FIG. 4, it can be seen that the electrolyte membrane according to Example 1 provides higher qualify as compared to the Nafion electrolyte membrane.

It is thought that the electrolyte membrane for a fuel cell according to Example 1 provides improved quality, because leakage of phosphoric acid that shows proton conductivity is decreased to inhibit degradation of proton conductivity and impregnation with phosphoric acid is improved, as compared to the conventional electrolyte membrane for a fuel cell according to Comparative Example 1 or 2. In addition, the electrolyte membrane for a fuel cell according to the present disclosure provides proton conductivity improved significantly as compared to the Nafion electrolyte membrane, and thus can substitute for the Nafion electrolyte membrane and can be applied to various industrial fields as high-temperature electrolyte membrane. Further, the electrolyte membrane for a fuel cell according to the present disclosure inhibits degradation of proton conductivity even when if is used at a high temperature of 150° C. for a long time. Therefore, when using the electrolyte membrane according to the present disclosure for a fuel cell at room temperature, it is possible to provide significantly increased lifespan.

### Example 3

### Manufacture of Electrolyte Membrane Including Carbon Black and Silica-Based Metal-Grafted Porous Filler Dispersed Therein

### (1) Preparation of Silica-Based Metal-Grafted Porous Filler

To obtain a metal-grafted porous filler, 2 g of hexadecyltrimethyl ammonium bromide and 0.3 g of Brij-30 are dissolved in 38 g of distilled water, and 1 g of aluminum chloride is introduced to and dispersed in the solution. Then, 9 g of sodium silicate solution is added gradually thereto and the resultant mixture is introduced to an oven at 100° C. to carry out reaction for 2 days. The reaction mixture is taken out of the oven and cooled to room temperature. Next, 50% acetic acid solution is used to carry out titration of the solution gradually to pH 10. When pH reaches 10, the solution is introduced to an oven at 100° C. to carry out reaction for 2 days. The procedure including pH titration and reaction in an oven at 100° C. is repeated twice to have a sufficient period of time so that no change in pH may occur. Then, the mixture is taken out of the oven, washed with distilled water and filtered to obtain white powder, which is introduced to an oven at 100° C. and dried for 24 hours. After the powder is dried sufficiently, the resultant sample is washed with a washing solution containing ethanol and HCl at a mixing ratio of 100 mL:2.5 g, followed by agitation for 30 minutes and filtration. During the filtration, the white powder is washed with ethanol/HCl solution twice or three times. The washed white powder is dried sufficiently and fired at 550° C. for 7 hours to obtain a silica-based metal-grafted porous filler.

### (2) Manufacture of Electrolyte Membrane

Electrolyte membranes may be obtained by the following two methods, which are described hereinafter in detail.

1) First, 3.24 g (15.1 mmol) of 3,3′-diaminobenzidine and 2.51 g (15.1 mmol) of isophthalic acid are dissolved in 160 g of polyphosphoric acid together with 10 parts by weight of carbon black and 5, 10 or 20 parts by weight of the silica-based metal-grafted porous filler based on 100 parts by weight of polybenzimidazole polymer. Next, the reaction mixture is heated to a temperature of 220° C. under nitrogen atmosphere in a system equipped with a reflux device and reaction is carried out for 30 hours.

After the completion of the reaction, precipitate is collected in water. Then, neutralization is carried out with potassium hydroxide (KOH) to pH 7. The reaction mixture is washed thoroughly with boiling water, filtered and dried in a vacuum oven for 24 hours. The obtained m-PBI powder is dispersed in methanesulfonic acid, followed by casting of a membrane. Then, the membrane is cured in an oven in a stepwise manner at 80° C for 1 hour, at 100° C. for 1 hour, at 120° C. for 1 hour and at 160° C. for 2 hours to obtain an electrolyte membrane for a fuel cell including carbon black and silica-based metal-grafted porous filler dispersed therein.

2) First, 3.24 g (15.1 mmol) of 3,3′-diaminobenzidine and 2.51 g (15.1 mmol) of isophthalic acid are dissolved in 160 g of polyphosphoric acid. Next, the reaction mixture is heated to a temperature of 220° C. under nitrogen atmosphere in a system equipped with a reflux device and reaction is carried out for 30 hours.

After the completion of the reaction, precipitate is collected in wafer. Then, neutralization is carried out with potassium hydroxide (KOH) to pH 7. The reaction mixture is washed thoroughly with boiling water, filtered and dried in a vacuum oven for 24 hours. The obtained m-PBI powder is added to and dissolved in a solution containing 10 parts by weight of carbon black and 5 (Example 3-1), 10 (Example 3-2) or 20 (Example 3-3) parts by weight of the silica-based metal-grafted porous filler, based on 100 parts by weight of polybenzimidazole polymer, dispersed sufficiently in methanesulfonic acid, followed by casting of a membrane. Then, the membrane is cured in an oven in a stepwise manner at 80° C. for 1 hour, at 100° C. for 1 hour, at 120° C. for 1 hour and at 160° C. for 2 hours to obtain an electrolyte membrane for a fuel cell including carbon black and silica-based metal-grafted porous filler dispersed therein.

### Test Example 2

### Determination of Proton Conductivity

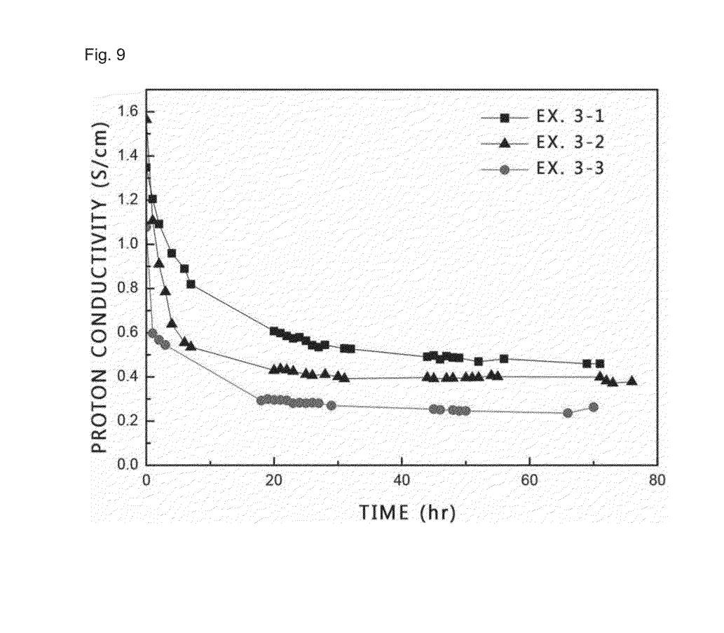

Autolab impedance analyzer and a proton conductivity cell are used to determine the proton conductivity of the electrolyte membrane including carbon black and metal-grafted porous filler introduced thereto according to Example 3, and the results are shown in the following Table 3 and in FIG. 9 in the form of a diagram. Determination of proton conductivity is carried out at a temperature of 150° C. under a non-humidified condition.

TABLE 3

| Example 3-1 | | Example 3-2 | | Example 3-3 | |
|---|---|---|---|---|---|
| | Proton | | Proton | | Proton |
| Time | conductivity | | conductivity | | conductivity |
| (hr) | (S/cm) | Time (hr) | (S/cm) | Time (hr) | (S/cm) |
| 0 | 1.07828 | 0 | 1.56433 | 0 | 1.34784 |
| 1 | 0.59723 | 1 | 1.10711 | 1 | 1.20463 |
| 2 | 0.56741 | 2 | 0.90971 | 2 | 1.09143 |
| 3 | 0.54413 | 3 | 0.78508 | 4 | 0.95852 |
| 18 | 0.29206 | 4 | 0.63908 | 6 | 0.88908 |
| 19 | 0.2994 | 6 | 0.55486 | 7 | 0.81862 |
| 20 | 0.29516 | 7 | 0.5354 | 20 | 0.60646 |
| 21 | 0.29568 | 20 | 0.42932 | 21 | 0.5977 |
| 22 | 0.29326 | 21 | 0.43592 | 22 | 0.58457 |
| 23 | 0.28043 | 22 | 0.43206 | 23 | 0.57359 |
| 24 | 0.28249 | 23 | 0.42494 | 24 | 0.57924 |
| 25 | 0.28027 | 25 | 0.41148 | 25 | 0.56327 |
| 26 | 0.28265 | 26 | 0.40663 | 26 | 0.54335 |
| 27 | 0.28058 | 28 | 0.41123 | 27 | 0.53456 |
| 29 | 0.26983 | 30 | 0.40092 | 28 | 0.54428 |
| 45 | 0.25368 | 31 | 0.39216 | 31 | 0.52863 |
| 46 | 0.25088 | 44 | 0.39722 | 32 | 0.52612 |
| 48 | 0.24938 | 45 | 0.39216 | 44 | 0.49036 |
| 49 | 0.24606 | 47 | 0.39293 | 45 | 0.49681 |
| 50 | 0.24522 | 48 | 0.3937 | 46 | 0.47931 |
| 66 | 0.23563 | 50 | 0.39565 | 47 | 0.49382 |
| 70 | 0.26288 | 51 | 0.39604 | 48 | 0.4877 |
| | | 52 | 0.39643 | 49 | 0.48517 |
| | | 54 | 0.40564 | 52 | 0.46869 |
| | | 55 | 0.40092 | 56 | 0.48115 |
| | | 71 | 0.39841 | 69 | 0.45964 |
| | | 72 | 0.38204 | 71 | 0.45876 |
| | | 73 | 0.37175 | | |
| | | 76 | 0.37771 | | |

In table 3 and FIG. 9, it can be seen that proton conductivity decreases as the service time of an electrolyte membrane for a fuel cell increases. However, the width of such a decrease is stabilized with the lapse of time. It can be seen from the results of Example 3 that as the content of the metal-grafted porous filler in an electrolyte membrane increases, the quality of an electrolyte membrane is improved significantly (larger than 0.45 S/cm). This is because the electrolyte membrane for a fuel cell according to Example 3 exhibits reduced leakage of phosphoric acid that shows proton conductivity, and thus inhibits degradation of proton conductivity and impregnation with phosphoric acid is improved significantly, as compared to the conventional electrolyte membranes for a fuel cell according to Comparative Examples 1 and 2. In addition, as compared to the Nafion electrolyte membrane, the electrolyte membrane according to Example 3 shows significantly improved qualify in terms of proton conductivity. Thus, it is expected that the electrolyte membrane according to the present disclosure can substitute for the Nafion electrolyte membrane and can be applied to various industrial fields as high-temperature electrolyte membrane.

### INDUSTRIAL APPLICABILITY

The polymer electrolyte membrane for a fuel cell according to the present disclosure includes carbon black or carbon black and a silica-based metal-grafted porous filler dispersed efficiently in a polybenzimidazole-based polymer on the surface thereof, wherein the carbon black or carbon black and a silica-based metal-grafted porous filler produce chemical bonds forming branches between chains and are dispersed physically in the interstitial volumes of chains. Thus, the electrolyte membrane according to the present disclosure shows excellent mechanical and thermal properties, provides an increased effect of impregnation with phosphoric acid to show high proton conductivity, and inhibits degradation of ion conductivity of an electrolyte membrane caused by leakage of phosphoric acid.

1. A polymer electrolyte membrane for a fuel cell, comprising: a polybenzimidazole polymer; and carbon black, wherein the polybenzimidazole is a polymer including at least one of the repeating units represented by the following Chemical Formula 1-Chemical Formula 4, and the carbon black is used in m amount of 1-50 parts by weight based on 100 parts by weight of the polybenzimidazole polymer: 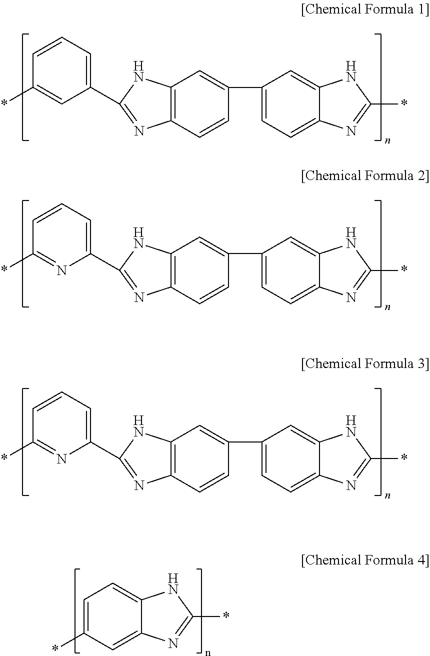
wherein n is an integer of 50-100,000.

2. The polymer electrolyte membrane for a fuel cell according to claim 1, which further comprises a silica-based metal-grafted porous filler, and the metal-grafted porous filler is present in an amount of 0.1-30 parts by weight based on 100 parts by weight of the polybenzimidazole polymer.

3. The polymer electrolyte membrane for a fuel cell according to claim 1, wherein the repeating units represented by the above Chemical Formula 1-Chemical Formula 4 are obtained by reacting a monomer represented by the following Chemical Formula 5 with any one monomer selected from the group consisting of the following Chemical Formula 6-Chemical Formula 8, or reacting a monomer represented by the following Chemical Formula 9:

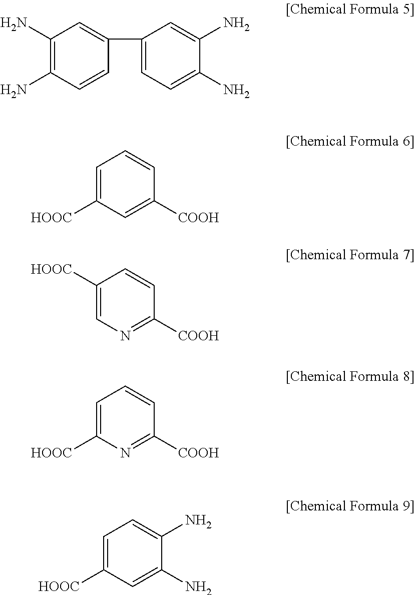 [SMILES: Nc1ccc(-c2ccc(N)c(N)c2)cc1N ; O=C(O)c1cccc(C(=O)O)c1 ; O=C(O)c1ccc(C(=O)O)nc1 ; O=C(O)c1cccc(C(=O)O)n1 ; Nc1ccc(C(=O)O)cc1N]

4. The polymer electrolyte membrane for a fuel cell according to claim 1, wherein the repeating units represented by the above Chemical Formula 1-Chemical Formula 3 are obtained according to the following Reaction Scheme 1: 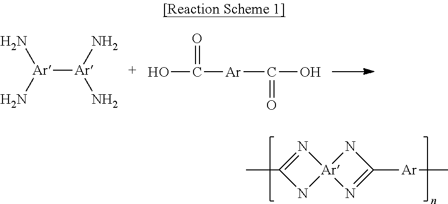
wherein Ar′ is a C6-C24 aryl group present alone or at least two aryl groups are bound to each other to form a condensed ring, Ar is a C6-C18 aryl group or C6-C18 hetero group, and n is an integer of 50-100,000.

5. The polymer electrolyte membrane for a fuel cell according to claim 1, wherein the carbon black is selected from lamp black, channel black, thermal black, acetylene black and furnace black.

6. The polymer electrolyte membrane for a fuel cell according to claim 1, wherein the carbon black comprises at least one functional group selected from a carboxyl group, hydroxyl group, ketone, lactone, pyrone and quinone.

7. The polymer electrolyte membrane for a fuel cell according to claim 1, wherein the polybenzimidazole is a copolymer of two types of repeating units selected from the above Chemical Formula 1-Chemical Formula 4, and the two types of repeating units are used in a molar ratio of 5:95-95:5.

8. A method for manufacturing a polymer electrolyte membrane for a fuel cell, comprising the steps of:
(a) dispersing carbon black in an acidic solution to provide a dispersion solution;
(b) reacting a monomer represented by the following Chemical Formula 5 with any one monomer selected from the monomers represented by the following Chemical Formula 6-Chemical Formula 8, or reacting a monomer represented by the following Chemical Formula 9 to provide a polybenzimidazole polymer;
(c) mixing the dispersion solution of step (a) with the polybenzimidazole polymer of step (b), followed by agitation; and
(d) casting the resultant mixed solution, followed by thermal curing

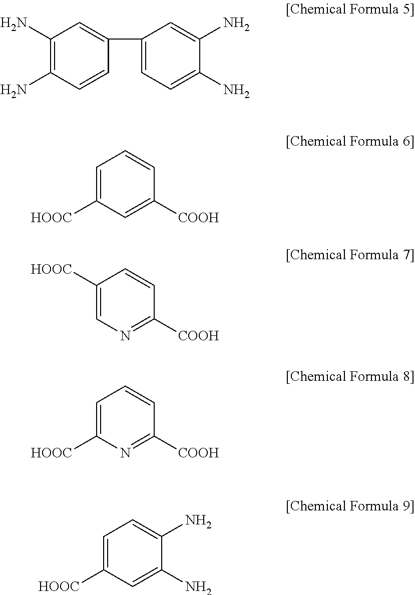 [SMILES: Nc1ccc(-c2ccc(N)c(N)c2)cc1N ; O=C(O)c1cccc(C(=O)O)c1 ; O=C(O)c1ccc(C(=O)O)nc1 ; O=C(O)c1cccc(C(=O)O)n1 ; Nc1ccc(C(=O)O)cc1N]

9. The method for manufacturing a polymer electrolyte membrane for a fuel cell according to claim 8, wherein a silica-based metal-grafted porous filler is further dispersed in the acidic solution in addition to carbon black, in step (a).

10. A method for manufacturing a polymer electrolyte membrane for a fuel cell, comprising the steps of:
(a) adding carbon black, a monomer represented by the following Chemical Formula 5, and any one monomer selected from the monomers represented by the following Chemical Formula 6-Chemical Formula 8 to an acidic solution, and carrying out reaction to provide a mixed solution containing solid content;
(b) adding carbon black and a monomer represented by the following Chemical Formula 9 to an acidic solution and carrying out reaction to provide a mixed solution containing solid content; and
(c) casting the mixed solution of step (a) or (b), followed by thermal curing:

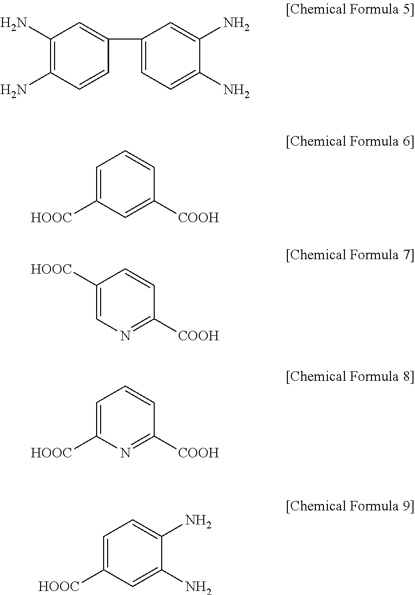 [SMILES: Nc1ccc(-c2ccc(N)c(N)c2)cc1N ; O=C(O)c1cccc(C(=O)O)c1 ; O=C(O)c1ccc(C(=O)O)nc1 ; O=C(O)c1cccc(C(=O)O)n1 ; Nc1ccc(C(=O)O)cc1N]

11. The method for manufacturing a polymer electrolyte membrane for a fuel cell according to claim 10, wherein a silica-based metal-grafted porous structure is further added to carry out reaction, in step (a) and step (b).

12. The method for manufacturing a polymer electrolyte membrane for a fuel cell according to claim 8, wherein the acidic solution is polyphosphoric acid or methanesulfonic acid.

13. The method for manufacturing a polymer electrolyte membrane for a fuel cell according to claim 8, wherein the solid content is present in an amount of 5-50 wt % based on the weight of the mixed solution.

14. A fuel cell using the polymer electrolyte membrane for a fuel cell as defined in claim 1.
